(19) United States
(12) Patent Application Publication
(10) Pub. No.: US 2007/0259138 A1
(43) Pub. Date: Nov. 8, 2007

(54) Wet tissue packaging

(76) Inventor: Luis Alberto Torres Santini, Barbera Del Valles, (Barcelona) (ES)

Correspondence Address: WILLIAM COLLARD;COLLARD & ROE, P.C., 1077 NORTHERN BOULEVARD, ROSLYN, NY, 11576, US

(21) Appl. No.: 11/800,216

(22) Filed: May 4, 2007

(30) Foreign Application Priority Data
May 4, 2006 (EP) EP 06 009 199.8

(51) Int. Cl. B32B 27/10; B32B 27/32; G09F 3/00

(52) U.S. Cl. 428/34.2; 428/43; 428/35.2

(57) ABSTRACT

A wet tissue packing for wet tissues consisting of a multilayer imprinted film which is adapted to form a sealed bag. The film is formed as a co-extrusion film and the inside surface of the bag is formed from a sealing layer of the co-extrusion film and the outside surface of the bag is formed from an imprintable outer layer of the co-extrusion film. At least portions of the outer layer are imprinted, and the outer layer is provided with a protective lacquer.

### BACKGROUND OF THE INVENTION

1. Field of the Invention

The invention relates to wet tissue packing for wet tissues consisting of a multilayer printed film adapted to form a sealed bag. Typically, wet tissues are arranged in a tightly sealed bag, either folded flat and stacked on top of each other or arranged as a roll, from which tissues can be torn off individually. Due to the imprint on the wet tissue packing, the film can be graphically designed or be provided with product information. Typically wet tissues are wetted with, or soaked in, a solution and are, for example, offered as wet tissues (wipes) for babies, cleaning tissues, hygiene tissues or freshening tissues.

2. The Prior Art

Wet tissue packing for wet tissues exhibiting the features mentioned above is well known in practice, whereby layers of film made from polyethyleneterephthalate (PET) and polyethylene (PE) or biaxially orientated polypropylene (BOPP) and polyethylene (PE) are laminated to form a compound film using a polyurethane-based adhesive. The migration of the constituents of the solution with which the wet tissues are wetted or soaked, may cause the laminating adhesive and the imprint inside the compound film to decompose. This can lead, in particular, to undesired delaminating of the compound film and fading of the printing ink. These undesired effects are particularly noticeable if a tear-open tissue removal zone is provided, which is surrounded by a weakening line and covered by an adhesive film for resealing. Substances which have penetrated into the film of the bag in the area of a weakening line are prevented from escaping easily by the adhesive film acting as barrier and are stored in the pressure sensitive adhesive of the adhesive film, so that decomposition of the laminating adhesive and the change in the printing ink are particularly noticeable. Moreover, the laminating process is very laborious. Further processing of the compound film cannot take place until the laminating adhesive has hardened.

### SUMMARY OF THE INVENTION

It is therefore an object of the invention to provide a wet tissue packing for wet tissues exhibiting the features mentioned above which can be easily manufactured and is durable.

According to the invention, this object is accomplished in that the film is formed as a co-extrusion film, and the inside surface of the bag is formed from a sealing layer of the co-extrusion film and the outside surface of the bag is formed from an imprintable outer layer of the co-extrusion film. At least portions of the outer layer are imprinted and the outer layer is provided with a protective lacquer. Typically the bag is formed from a folded film portion or by two sheets of film and preferably tightly sealed by sealing seams. By using a co-extrusion film, good durability of the wet tissue packing is ensured, whereby manufacture of the co-extrusion film is inexpensive and can be achieved by means of a simple process. The outer layer of the co-extrusion film which forms the outside surface of the bag is provided with an imprint. At least the imprinted areas of the outside surface of the bag are covered by a thin protective lacquer which preferably exhibits high chemical and mechanical resistance and protects the imprinted areas. Depending on the choice of protective lacquer, the outside surface of the bag may be finished in mat or gloss, and may be different for portions thereof.

Within the framework of the invention, protective lacquers which harden reactively are particularly suitable. In contrast to water-soluble adhesives or solvents, reactively hardening protective lacquers harden through a conversion of matter. Preferred are one-component or two-component reactive systems, for example, which harden through mixing, through contact with ambient air or under the influence of energy-rich radiation such as UV radiation. Nevertheless, non-reactive lacquers are applicable within the scope of the present invention. Non-reactive lacquers are typically cheap, easy to use and especially adequate for wet tissue packings which are not stored for a very long time or which contain a less aggressive solution.

In a preferred embodiment of the invention, the sealing layer of the co-extrusion film consists mainly or wholly of polyethylene, polyethylene copolymer, an ionomer, polypropylene, a polypropylene-polyethylene-copolymer or a mixture of these polymers. When using polyethylene, it is preferable to use a type of polyethylene with low density, for example PE-LD, PE-VLD or PE-LLD or a polyethylene manufactured using Metallocen catalysers such as PE-LDm, PE-VLDm or PE-LLDm. Especially suited polyethylene copolymers are, for example, ethylene-vinyl acetate copolymers (EVA) and ethylene acryl copolymer (e.g. EAA, EMA).

The outer layer which forms the outside surface of the bag has good imprintability and preferably consists mainly or wholly of a polypropylene homopolymer (PP-H), a polypropylene random copolymer, a polypropylene block copolymer or a mixture thereof. When selecting the polymers for the layers of the at least two-layer co-extrusion film, it is important to take the different melting temperatures into account, since the outer layer is usually not be melted on, when the sealing layer is sealed. Particularly preferable is an embodiment in which the co-extrusion film consists wholly or mainly of polyolefins, thus allowing simple recycling of the film. The co-extrusion film may contain some minor amounts of additives, such as slip agents, processing aids, thermal stabilizers and anti-blocking agents. The percentage weight of these admixtures in relation to the co-extrusion film as a whole is usually below 3%. By using these admixtures, the functional properties of the co-extrusion film can be precisely adapted to the requirements. In addition, color pigments for coloring the bag may also be provided in one layer or in several layers.

Within the framework of the invention, the overall thickness of the co-extrusion film is typically more than 40 μm, preferably more than 60 μm and typically less than 120 μm, preferably less than 80 μm. As compared to known prior art compound films which are made from biaxially orientated polypropylene and polyethylene or polyethyleneterephthalate and polyethylene, the design of the film according to the invention as a co-extrusion film, which preferably consists mainly or wholly of polyolefins, achieves improved tear resistance and improved resistance against perforation caused by repeated bending.

Furthermore, with the co-extrusion film, it is possible to vary layer construction and the selection of raw materials over a wide range, allowing the stiffness and the running properties of the co-extrusion film to be adapted in many ways during a processing operation.

In an advantageous embodiment of the invention, the bag comprises a tear-open tissue removal zone which is surrounded by a weakening line. The weakening line may, for example, be formed as a continuous linearly shaped material weakening and/or as an equidistantly interrupted, linearly shaped material weakening. The material weakening might be created for example by cutting, a local reduction of the film thickness and/or a local embrittlement or partially destruction of the polymeric structures. Advantageously, the removal zone is arranged on the top side of the wet tissue packing and facilitates easy extraction of the wet tissues from the inside of the bag. In an advantageous embodiment of the invention the tissue removal zone is covered by adhesive film for resealing.

The co-extrusion film can consist of the sealing layer and the outer layer or may without any limitation comprise a core of one single layer or multiple layers. In a preferred embodiment of the invention, the co-extrusion film comprises three layers. A core layer is arranged between the sealing layer and the outer layer. The core layer may, for instance, be arranged to match the polymers of the sealing layer and the outer layer in such a way that high bonding strength is ensured. In contrast to the sealing layer, which must have good sealability, and the outer layer, which must allow easy imprinting, the properties of the core layer can be very flexibly adapted to many different requirements. With a three-layer co-extrusion film, the thickness of the core layer is typically between ⅓ and ¾ and preferably between ⅖ and ⅗ of the overall thickness of the co-extrusion film.

The design of the wet tissue packing according to the invention facilitates an optically pleasing appearance. Since the imprint is arranged directly on the outer surface of the bag and only covered by a thin layer of the protective lacquer, special printing effects such as pearl effects or 3D effects can be very eye-catching. Moreover, the outer surface of the bag may be embossed in addition to the imprint.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a wet tissue packing for wet tissues; and

FIG. 2 shows the construction of a multilayer imprinted co-extrusion film.

### DETAILED DESCRIPTION OF THE PREFERRED EMBODIMENT

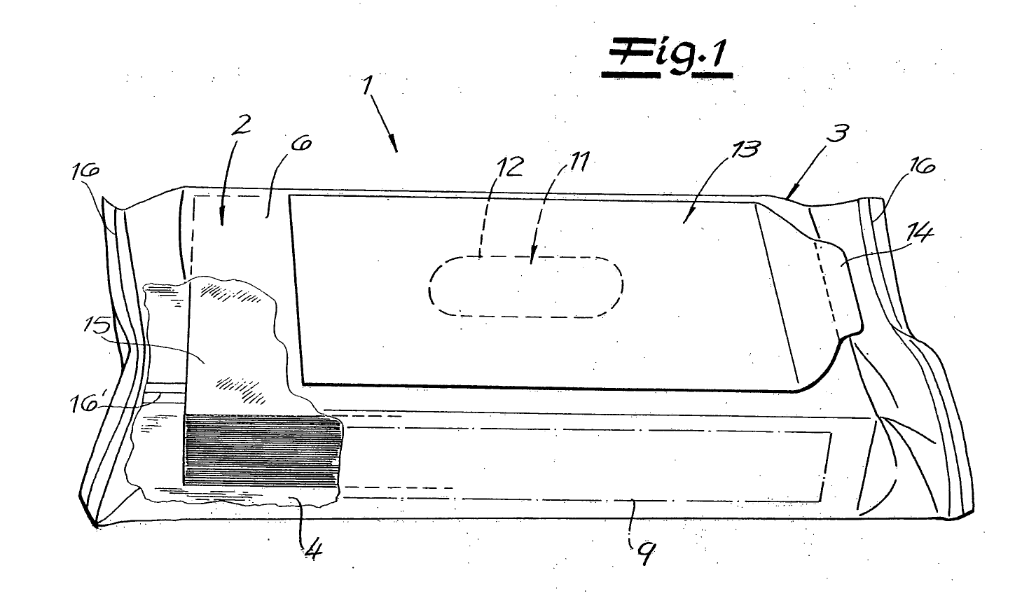

Referring now in detail to the drawings, FIG. 1 shows a wet tissue packing 1 with an imprinted co-extrusion film 2 adapted to form a sealed bag 3. The inside surface 4 of bag 3 is formed from a sealing layer 5 and the outside surface 6 is formed from an outer layer 7 of co-extrusion film 2. Portions of outer layer 7 of co-extrusion film 2 are provided with an imprint 8, whereby imprinted areas 9 are covered with a thin layer of a protective lacquer 10, which is preferably a reactively hardening protective lacquer. On the top side of wet tissue packing 1, a tear-open tissue removal zone 11 of bag 3 is provided which is surrounded by a weakening line 12. An adhesive film 13 for resealing covers tissue removal zone 11 of the bag 3. The adhesive film 13 comprises a non-adhesive end portion 14 used for pulling the adhesive film 13 off bag 3. Tissue removal zone 11 is separated out along weakening line 12 when the packing is opened for the first time. In order to reseal the wet tissue packing after extraction of a wet tissue 15, adhesive film 13 is placed flat on bag 3 again. Bag 3 is formed from a film portion by folding it up, and sealed by two rim-side sealing seams 16 and one sealing seam 16′ extending in a longitudinal direction.

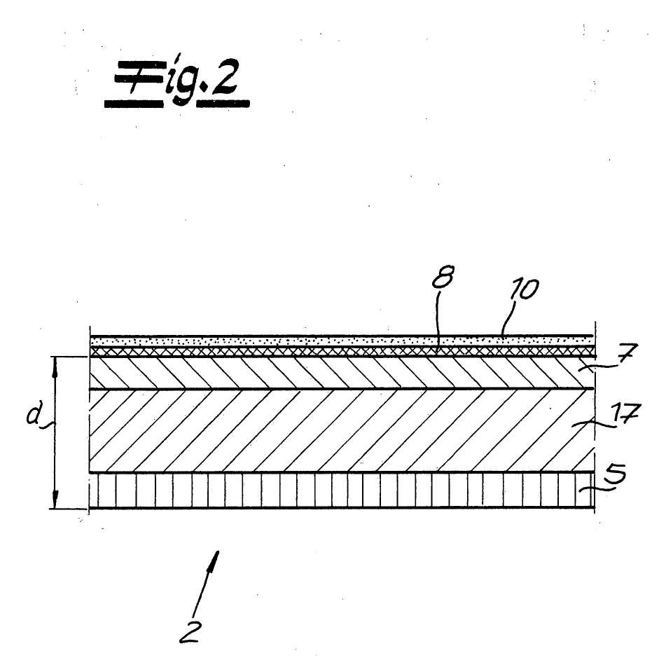

FIG. 2 depicts the construction of co-extrusion film 2. Co-extrusion film 2 consists of three layers which form a sealing layer 5, a core layer 17 and an outer layer 7. Outer layer 7 which mainly or wholly consists of polypropylene homopolymer, polypropylene random copolymer, polypropylene block copolymer or a mixture thereof, carries an imprint 8 which is covered by a reactively hardening protective lacquer 10. Sealing layer 5 of co-extrusion film 2 consists mainly or wholly of a polyethylene, a polyethylene copolymer, an ionomer, polypropylene, a polypropylene-polyethylene-copolymer or a mixture of these polymers. The polymers are chosen in such a way that the melting temperature of sealing layer 5 is noticeably lower than that of outer layer 7. The thickness of core layer 17 lies between ⅓ and ¾, preferably between ⅖ and ⅗ of the overall thickness of the co-extrusion film 2. The overall thickness d is typically more than 40 μm, preferably more than 60 μm and typically less than 120 μm, preferably less than 80 μm. Apart from admixtures from the group of internal lubricants, processing agents, thermal stabilizers, anti-blocking agents and color pigments, the entire co-extrusion film 2 consists of polyolefins.

In an actual embodiment of co-extrusion film 2, sealing layer 5 has a thickness of 15 μm, with 25 percent by weight consisting of PE-LD and 75 percent by weight consisting of PE-VLDm. Core layer 17 has a thickness of 39 μm with 69 percent by weight consisting of PP-H and 20 percent by weight consisting of thermoplastic polyolefin elastomer, the rest consisting of color pigments (white batch). The imprintable outer layer has a thickness of 16 μm with 70 percent by weight consisting of PP-H and 30 percent by weight consisting of polypropylene random copolymer. A tensile strength test was performed to ascertain the tensile strength of the previously unloaded co-extrusion film 2, its tensile strength at 5% elongation and at 10% elongation as well as the elongation at tear of co-extrusion film 2 in running direction (MD) and in cross direction (CD). The tensile strength is given in Newton N per inch (25.4 millimeter) width of the 70 μm thick co-extrusion film 2. The stated elongation refers to the change in length of an initially 1 inch wide test strip of the co-extrusion film 2 compared to the overall length of the previously unloaded strip. The mechanical properties of co-extrusion film 2 are shown in table 1. Apart from a good tensile strength, the co-extrusion film 2 also exhibits very good properties when running through the machine. The shelf-life of co-extrusion film 2 was checked by ascertaining its weight loss in an oven held at 40°. The weight loss measured at the beginning of storage was a mere 0.8 ‰ per day, meaning that the co-extrusion film has a good shelf life.

TABLE 1

| | | |
|---|---|---|
| Tensile strength MD | N/inch | 119 |
| Tensile strength CD | N/inch | 66 |
| Toughness at 5% elongation MD | N/inch | 31 |
| Toughness at 5% elongation CD | N/inch | 31 |
| Toughness at 10% elongation MD | N/inch | 39 |
| Toughness at 10% elongation CD | N/inch | 37 |
| Elongation at tear MD | % | 800 |
| Elongation at tear CD | % | 860 |

Accordingly, while only a few embodiments of the present invention have been shown and described, it is obvious that many changes and modifications may be made thereunto without departing from the spirit and scope of the invention.

What is claimed is:

1. A wet tissue packing for wet tissues comprising:
a multilayer printed film adapted to form a sealed bag, said film being formed as a co-extrusion film, wherein an inside surface of the bag is formed from a sealing layer of the co-extrusion film and an outside surface of the bag is formed from an imprintable outer layer of the co-extrusion film, and wherein at least portions of the outer layer are imprinted and the outer layer is provided with a protective lacquer.

2. The wet tissue packing according to claim 1, wherein the bag contains a tear-open tissue removal zone which is surrounded by a weakening line.

3. The wet tissue packing according to claim 2, wherein the wet tissue packing contains an adhesive film for resealing, which covers the tissue removal zone of the bag.

4. The wet tissue packing according to claim 1, wherein the sealing layer of the co-extrusion film consists mainly or wholly of a material selected from the group consisting of polyethylene, polyethylene copolymer, an ionomer, polypropylene, a polypropylene-polyethylene-copolymer and a mixture of these polymers.

5. The wet tissue packing according to claim 1, wherein the outer layer of the co-extrusion film consists mainly or wholly of a material selected from the group consisting of polypropylene homopolymer (PP-H), a polypropylene random copolymer, a polypropylene block copolymer and a mixture thereof.

6. The wet tissue packing according to claim 1, wherein the co-extrusion film consists of polyolefins.

7. The wet tissue packing according to claim 1, wherein the protective lacquer is reactively hardening.

8. The wet tissue packing according to claim 1, wherein the co-extrusion film has an overall thickness of more than 40 μm.

9. The wet tissue packing according to claim 1, wherein the co-extrusion film contains at least an admixture selected from the group consisting of slip agents, processing aids, thermal stabilisers, anti-blocking agents and colour pigments.

10. The wet tissue packing according to claim 1, wherein the co-extrusion film comprises three layers, one of said three layers being a core layer, and wherein a thickness of the core layer is between ⅓ and ¾ of an overall thickness (d) of the co-extrusion film (2).
